(19) United States
(12) Patent Application Publication
(10) Pub. No.: US 2003/0146702 A1
(43) Pub. Date: Aug. 7, 2003

(54) Planar discharge display device

(76) Inventor: Yoshifumi Amano, Kanagawa (JP)

Correspondence Address: William S Frommer, Frommer Lawrence & Haug, 745 Fifth Avenue, New York, NY, 10151, US

(21) Appl. No.: 10/240,386

(22) PCT Filed: Jan. 29, 2002
(86) PCT No.: PCT/JP02/00662

(30) Foreign Application Priority Data
Jan. 29, 2001 (JP) 2001-60905

(51) Int. Cl. H01J 17/49

(52) U.S. Cl. 313/584; 313/485; 313/493

(57) ABSTRACT

The present invention is to provide a planar discharge display device including projection-like structure members (8) respectively formed on spaces between a plurality of unit discharge display portions and unit discharge display portions adjoining to the respective unit discharge display portions of one and the other of a rear glass substrate (1) and a front glass substrate (12), recesses (11) engaged with the projection-like structure members (8) and glass frits (14), (13) respectively interposed on the surrounding portions of the rear glass substrate (1) and the front glass substrate (12) and between the respective projection-like structure members (8) and the recesses (11) engaged with the projection-like structure members (8) in which the rear glass substrate (1) and the front glass substrate (12) are joined with pressure under the condition in which the glass frits (14), (13) are being heated to thereby form a vacuum flat tube-assembly into which a discharge gas is filled. According to this planar discharge display device, there can be removed a risk in which the space between the rear glass substrate (1) and the front glass substrate (12) will cause erroneous discharge to occur to generate crosstalk or a risk in which adhesion failure will be caused by uneven thickness of the glass frit (13). Moreover, since the amount of the glass frit coated on the surrounding portions of the rear glass substrate (1) and the front glass substrate (12) is decreased, a large number of unit discharge display portions can be integrated to the extent that spacers among a plurality of unit discharge display portions may become inconspicuous. In addition, owing to the existence of a plurality of projection-like structure members (8) and a plurality of recesses (11) which are engaged with these projection-like structure members, there can be obtained the planar discharge display device in which misalignment between the rear glass substrate (1) and the front glass substrate (12) in the plane direction can be avoided.

### TECHNICAL FIELD

The present invention relates to a planar discharge display device in which glass frits are coated not only around a front glass substrate and a rear glass substrate but also on the spaces between a plurality of unit discharge display portions and the adjacent unit discharge display portions of a front glass substrate and then the front glass substrate and a rear glass substrate are joined by the glass frits to thereby form a flat tube-assembly.

### BACKGROUND ART

In a general structure of a planar discharge display device called a PDP (Plasma Display Panel) according to the prior art, a front glass substrate and a rear glass substrate in which respective members such as electrodes, ribs and fluorescent substances are provided are opposed to each other and are brought in contact with each other such that respective members are assembled together in a predetermined relationship and the surrounding portions of the two glass substrates are joined by glass frits and sealed in vacuum, thereby forming a planar discharge display device having a flat tube-assembly.

In this case, in the inside of the flat tube-assembly, the members formed on the two glass substrates are only contacted with each other but are not joined together. Then, in the planar discharge display device having such structure, since the two glass substrates are joined at the glass frit portions of the surrounding portions, a frit coating width of a certain width, i.e., so-called margin is required in order to maintain adhesive strength. A width of this margin generally ranges approximately several millimeters to 10 millimeters.

Accordingly, the assignee of the present application has previously proposed a planar discharge display device in which glass frits are coated not only on the surrounding portions of the front glass substrates and the rear glass substrates but also on spaces between unit discharge display portions of a plurality of unit discharge display portions [one cell or a plurality of discharge cells (pixel of single color or pixel comprising a set of three primary colors)] of a front glass substrate and a rear glass substrate and adjacent discharge display portions and the front glass substrate and the rear glass substrate are joined by such glass frits to thereby form a flat tube-assembly [see (Japanese patent application No. 7-317626) and (Japanese laid-open patent application No. 9-129143)]. In the planar discharge display device of this case, a plurality of unit discharge display portions are provided in an XY matrix fashion.

In such planar discharge display device, since the glass frits are coated on not only the surrounding portions of the front glass substrate and the rear glass substrate but also on the spaces between a plurality of unit discharge display portions and the adjacent to join the front glass substrate and the rear glass substrate, distortions and stress of the front glass substrate and the rear glass substrate are dispersed and burden imposed upon the frits coated on the surrounding portions of the front glass substrate and the rear glass substrate can be reduced considerably. Therefore, the widths of the glass frits coated on the surrounding portions of the front glass substrate and the rear glass substrate can be minimized.

However, in such planar discharge display device, depending upon the thickness of the glass frit coated on the spaces between the respective unit discharge display portions of a plurality of unit discharge display portions and the adjacent unit discharge display portions of the front glass substrates and the rear glass substrates, a gap is produced between the front glass substrate and the rear glass substrate so that discharge occurs unintentionally to cause crosstalk to occur. Moreover, because the thickness of the glass frit is not uniform, there arises a problem such as bonding failure.

In view of the aforesaid aspect, according to the present invention, there is provided a planar discharge display device in which glass frit is coated on the surrounding portions of the rear glass substrate and the front glass substrate, glass frit is also coated on the spaces between a plurality of unit discharge display portions and the adjacent unit discharge display portions of the rear glass substrate and the front glass substrate and then the rear glass substrate and the front glass substrate are joined with pressure under the condition in which glass frit is being heated to thereby form a vacuum flat tube-assembly into which discharge gas is filled. In this planar discharge display device, there can be removed risks in which crosstalk is caused by erroneous discharge and in which bonding failure is caused due to uneven thickness of glass frits.

### DISCLOSURE OF INVENTION

According to the first invention, there is provided a planar discharge display device including projection-like structure members provided in spaces between a plurality of unit discharge display portions and the adjacent unit discharge display portions of one and the other of a rear glass substrate and a front glass substrate, recesses engaged with the projection-like structure members and glass frits coated on the surrounding portions of the rear glass substrate and the front glass substrate and coated between the projection-like structure members and the recesses which are respectively engaged with the projection-like structure members, in which the rear glass substrate and the front glass substrates are joined with pressure under the condition in which glass frit is being heated to thereby form a vacuum flat tube-assembly into which discharge gas is filled.

According to the second invention, there is provided a planar discharge display device including recesses formed on spaces between a plurality of unit discharge display portions and unit discharge display portions adjoining to the respective unit discharge display portions of a front glass substrate and portions coated with fluorescent substances by sandblast or chemical etching, projection-like structure members respectively engaged with the recesses formed on the spaces between a plurality of unit discharge display portions and the unit discharge display portions adjoining to the respective unit discharge display portions and which are also engaged with the recesses formed on the spaces between a plurality of unit discharge display portions and the unit discharge display portions adjoining to the respective unit discharge display portions, fluorescent substances coated on the front glass substrate at its recesses coated with fluorescent substances and glass frits provided on the surrounding portions of the rear glass substrate and the front glass substrate and between the recesses and the respective projection-like structure members engaged with the respective recesses, in which the rear glass substrate and the front glass substrate are joined with pressure under the condition in which glass frit is being heated to thereby form a vacuum flat tube-assembly into which discharge gas is filled.

### BRIEF DESCRIPTION OF DRAWINGS

FIG. 1 is a perspective view showing a planar display device according to an embodiment of the present invention in an exploded fashion. FIG. 2 is a fragmentary cross-sectional view showing a planar display device according to an embodiment of the present invention. FIG. 3 is a fragmentary cross-sectional view showing a planar display device according to another embodiment of the present invention.

### BEST MODE FOR CARRYING OUT THE INVENTION

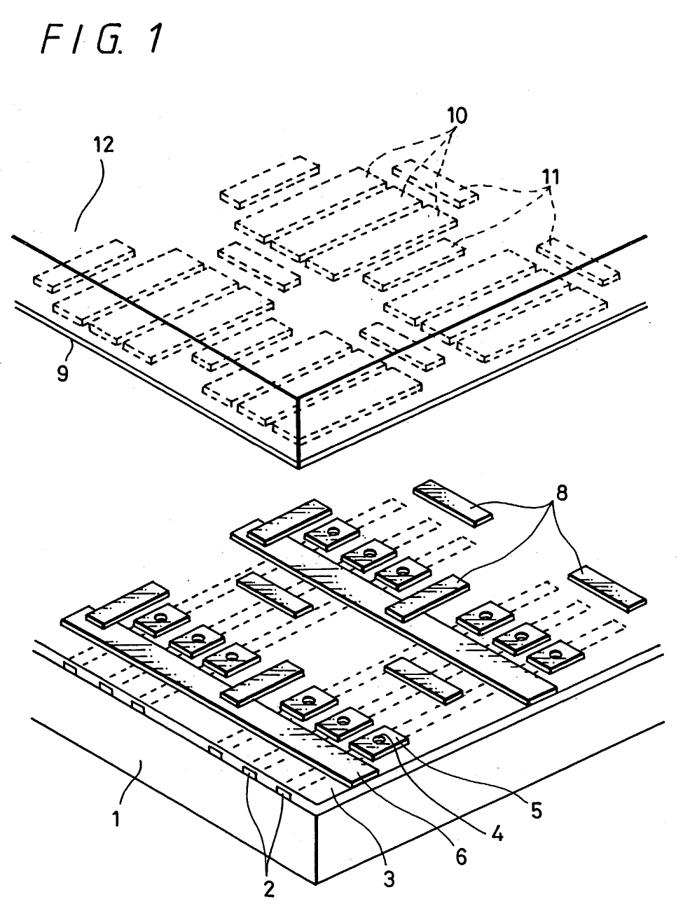

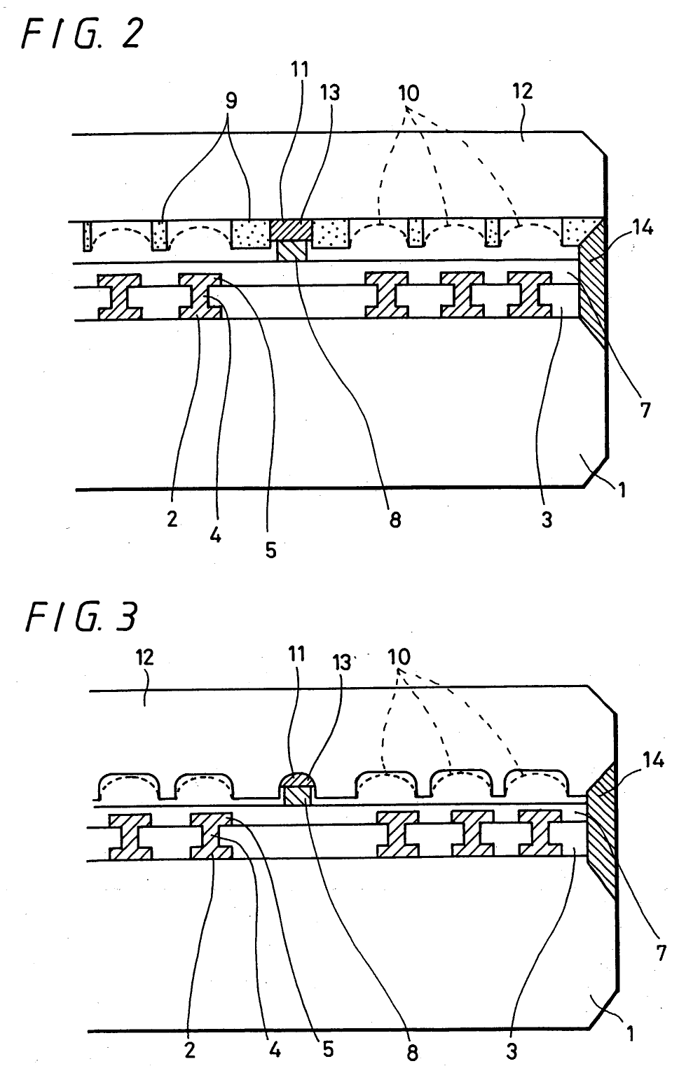

First, a structure of a planar discharge display device according to an embodiment of the present invention will be described with reference to FIGS. 1 and 2. FIG. 1 is an exploded perspective view of a planar discharge display device, and FIG. 2 is a fragmentary cross-sectional view thereof.

Projection-like structure members 8 formed on a rear glass substrate 1 and recesses 11 formed on a front glass substrate 12 characterize a planar discharge display device according to this embodiment. Alternatively, the projection-like structure members 8 may be formed on the front glass substrate 12 and the recesses 11 may be formed on the front glass substrate 1.

When the rear glass substrate 1 and the front glass substrate 12 are assembled, the projection-like structure member 8 and the recess 11 are opposed to each other. As shown in FIG. 2, the projection-like structure member 8 and the recess 11 are shaped so as to be engaged with each other and joined by glass frit 13 interposed between the projection-like structure member 8 and the recess 11.

To hold a flat tube-assembly comprising the rear glass substrate 1 and the front glass substrate 12 at the vacuum state, peripheral portions of the rear glass substrate 1 and the front glass substrate 12 are coated with another end-sealing glass frit 14.

Next, an overall structure of this planar discharge display device will be described with reference to FIGS. 1 and 2. Although discharge electrodes 2, 5 and 6 which are formed on the rear glass substrate 1 as shown in FIG. 1 are not directly related to the glass joint structure which is one of the characteristics of the present invention and are only examples for use in explaining the present invention, these discharge electrodes will be described below.

First, a plurality of first electrodes 2 is formed on the rear glass substrate 1 in parallel to each other by a suitable method such as screen-printing. Next, an insulating layer 3 is formed so as to cover a plurality of first electrodes 2.

The insulating layer 3 has through-holes 4 defined thereon. The through-holes 4 can be easily formed by a screen mask with a through-hole pattern at the same time the insulating layer 3 is formed with the screen mask by screen printing or the like.

A plurality of second electrodes 6 are formed on the insulating layer 3 in parallel to each other in such that they may cross a plurality of first electrodes 2, and a plurality of slit-like electrodes 5 are formed on the insulating layer through the through-holes 4 in such a manner that they may be connected to a plurality of electrodes 2, respectively. In this manner, the first and second electrodes 2 and 6 form an XY matrix, which may cross each other through the insulating layer 3. In actual practice, discharge is generated between a selected electrode of a plurality of second electrodes 6 and a selected electrode of a plurality of slit-like electrodes 5.

A plurality of second electrodes 6 are covered with a dielectric layer 7 and the dielectric layer 7 is covered with a protective layer (not shown) such as oxide magnesium and thereby an AC discharge electrodes are formed. Alternatively, a plurality of second electrodes may form DC electrodes without the dielectric layer 7.

After the electrodes and the like needed by discharge to display images have been formed as described above, as shown in FIGS. 1 and 2, a plurality of projection-like structure members 8 are formed on the dielectric layer 7. The projection-like structure members 8 can be easily formed at high accuracy by effecting lamination screen-printing on a suitable material such as low-melting glass.

The projection-like structure members 8 may be shaped freely so long as they can be fitted into the recesses 11 formed on the front glass substrate 12, which will be described later on, e.g., they may be shaped like plates, hemispheres and so on. Stated otherwise, the recesses 11 may be shaped in such a manner that they can be fitted into the projection-like structure members 8. After the projection-like structure members 8 have been formed, the joint frit 13 is coated on the upper surface of the projection-like structure members or the body of the projection-like structure members 8 and temporarily dried. The joint glass frit may be the same material as that of end-sealing glass frit 14 which is used to end-seal the peripheral portions of the rear glass substrate and the front glass substrate in the vacuum state or may be a different material depending upon the manufacturing process.

A proper height of the projection-like structure member 8 may fall within a range of from approximately 0.1 mm to approximately 0.2 mm when a thickness of rib patterns 9 on the front glass substrate 12 and a thickness of the joint glass frit 14 are considered as shown in FIG. 3.

Next, as shown in FIG. 2, the front glass substrate 12 has formed thereon a set of three recesses for use as a set of three pixels 10 which are respectively coated with red, blue and green fluorescent substances, and red, blue and green fluorescent substances may be coated on the recesses for use as a set of three pixels 10 and thereby a set of pixels 10 comprising the red, blue and green fluorescent substances are formed.

The unit discharge display portion is composed of one or a plurality of discharge cells (pixel of single color or pixel formed of a set of three primary colors).

The recess 11 engaged with the projection-like structure member 8 of the rear glass substrate 1 side is formed on the portion between the pixel 10 and the adjacent pixel. These pixel 10 and recess 11 are formed by a method similar to that, which is used to form a rib (rib) in an ordinary PDP. For example, when a general rib pattern 9 is formed, low-melting glass may be laminated with patterns by printing or rib members having a proper thickness, e.g., approximately ranging from 0.1 mm to 0.2 mm may be laminated on the whole and the laminated rib members may be treated with patterns by a suitable method such as sandblast. The ordinary rib pattern 9 is made of a black material in order to improve contrast. Fluorescent substances are coated on the recess of the pixel 10 thus formed by a suitable method such as screen-printing and bonding glass frit 13 is coated on the recess 11.

A plurality of projection-like structure members 8 and a plurality of recesses 11 which had been formed on the rear glass substrate 1 and the front glass substrate 12 in which respective members are formed are respectively engaged with each other through the glass frits 13. Further, the end-sealing glass frits 14 are coated on the surrounding portions of the rear glass substrate 1 and the front glass substrate 12. Thereafter, when the whole of the resultant product is heated at about 450° C., the glass frits 13 and 14 are melted to bond the two glass substrates 1, 12 and an air-tight flat tube-assembly which is vacuum tolerable in the inside can be constructed of the rear glass substrate 1 and the front glass substrate 12.

Then, in the later process, after the inside of the flat tube-assembly has been made vacuum temporarily, gas necessary for discharging, e.g., a mixed gas such as neon gas, argon gas or xenon gas is filled into the flat tube-assembly and thereby the planar discharge display device is formed.

Next, a structure of a planar discharge display device according to another embodiment of the present invention will be described with reference to a fragmentary cross-sectional view of FIG. 3. The planar discharge display device according to this embodiment is different from the planar discharge display device, which has been described so far with reference to FIGS. 1 and 2 in a method of forming the recess 11 and the pixel 10 on the front glass substrate 12 side. Specifically, although the recess 11 of the planar discharge display device and the recess of the pixel 10 shown in FIGS. 1 and 2 are formed by laminating the rib members on the flat plate glass, in the planar discharge display device shown in FIG. 3, the recess 11 and the recess of the pixel 10 are formed by directly engraving the front glass substrate 12 in accordance with a proper method such as sandblast or chemical etching.

When this recess 11 and the recess of the pixel 10 are formed, they may be formed in such a manner that a photosensitive resist film is deposited on a plate glass and a pattern to be formed is exposed and developed, whereafter they are formed by sandblast or chemical etching.

Processes following the processes in which respective recesses had been formed are similar to those of the planar discharge display device, which has been described so far with reference to FIGS. 1 and 2.

According to the first invention, since a planar discharge display device includes projection-like structure members provided in spaces between a plurality of unit discharge display portions and the adjacent unit discharge display portions of one and the other of a rear glass substrate and a front glass substrate, recesses engaged with the projection-like structure members and glass frits coated on the surrounding portions of the rear glass substrate and the front glass substrate, the respective projection-like structure members and the recesses in which the rear glass substrate and the front glass substrates are joined with pressure under the condition in which glass frit is being heated to thereby form a vacuum flat tube-assembly into which discharge gas is filled, there can be removed a risk in which the space between the rear glass substrate and the front glass substrate will cause erroneous discharge to occur to generate crosstalk or a risk in which bonding failure will be caused by uneven thickness of the glass frit. Moreover, since the amount of the glass frit coated on the surrounding portions of the rear glass substrate and the front glass substrate is decreased, a large number of unit discharge display portions can be integrated to the extent that spacers among a plurality of unit discharge display portions may become inconspicuous. In addition, owing to the existence of a plurality of projection-like structure members and a plurality of recesses which are engaged with these projection-like structure members, there can be obtained the planar discharge display device in which misalignment between the rear glass substrate and the front glass substrate in the plane direction can be avoided.

According to the second invention, since a planar discharge display device includes recesses formed on spaces between a plurality of unit discharge display portions and unit discharge display portions adjoining to the respective unit discharge display portions of a front glass substrate and portions coated with fluorescent substances by sandblast or chemical etching, projection-like structure members respectively engaged with the recesses formed on the spaces among a plurality of unit discharge display portions and the unit discharge display portions adjoining to the respective unit discharge display portions and which are also engaged with the recesses formed on the spaces between a plurality of unit discharge display portions and the unit discharge display portions adjoining to the respective unit discharge display portions, fluorescent substances coated on the front glass substrate at its recesses coated with fluorescent substances and glass frits provided on the surrounding portions of the rear glass substrate and the front glass substrate, the respective recesses and between the respective projection-like structure members engaged with the respective recesses in which the rear glass substrate and the front glass substrate are joined with pressure under the condition in which glass frit is being heated to thereby form a vacuum flat tube-assembly into which discharge gas is filled, there can be removed a risk in which the space between the rear glass substrate and the front glass substrate will cause erroneous discharge to occur to generate crosstalk or a risk in which bonding failure will be caused by uneven thickness of the glass frit. Moreover, since the amount of the glass frit coated on the surrounding portions of the rear glass substrate and the front glass substrate is decreased, a large number of unit discharge display portions can be integrated to the extent that spacers among a plurality of unit discharge display portions may become inconspicuous. Further, owing to the existence of a plurality of projection-like structure members and a plurality of recesses which are engaged with these projection-like structure members, there can be obtained the planar discharge display device in which misalignment between the rear glass substrate and the front glass substrate in the plane direction can be avoided. In addition, there can be obtained a planar discharge display device in which the recesses formed in the spaces between a plurality of unit discharge display portions and the unit discharge display portions adjoining to the respective unit discharge display portions and the recesses of the portions that should be coated with the fluorescent substances can be formed on the front glass substrate at the same time.

1. A planar discharge display device comprising:
projection-like structure members respectively provided on spaces between a plurality of unit discharge display portions of one and the other of a rear glass substrate and a front glass substrate and unit discharge display portions adjoining to said respective unit discharge display portions and recesses engaged with said projection-like structure members; and
glass frits respectively interposed on the surrounding portions of said rear glass substrate and said front glass substrate and between said projection-like structure members and said recesses which are respectively engaged with said projection-like structure members, wherein said rear glass substrate and said front glass substrate are joined to each other with pressure under the condition in which said glass frits are being heated to thereby form a vacuum flat tube-assembly into which a discharge gas is filled.

2. A planar discharge display device comprising:
recesses respectively formed on spaces between a plurality of unit discharge display portions and unit discharge display portions adjoining to said respective unit discharge display portions of a front glass substrate and formed on said front glass substrate at its portions in which fluorescent substances are to be coated by sandblast and chemical etching;
projection-like structure members respectively formed on the spaces between a plurality of unit discharge display portions and unit discharge display portions adjoining to said respective unit discharge display portions of a rear glass substrate and which are respectively engaged with said recesses respectively formed on the spaces between a plurality of unit discharge display portions and unit discharge display portions adjoining to said respective unit discharge display portions of said front glass substrate;
fluorescent substances coated on recesses of said front glass substrate at its portions which are to be coated with fluorescent substances; and
glass frits interposed between surrounding portions of said rear glass substrate and said front glass substrate and between said recesses and said respective projection-like structure members engaged with said recesses, wherein said rear glass substrate and said front glass substrate are joined to each other with pressure under the condition in which said glass frits are being heated to thereby form a vacuum flat tube-assembly into which discharge gas is filled.
